(19) United States
(12) Patent Application Publication
(10) Pub. No.: US 2023/0153754 A1
(43) Pub. Date: May 18, 2023

(54) PACKAGE PACKING METHOD AND ELECTRONIC DEVICE

(71) Applicants: Inventec (Pudong) Technology Corporation, Shanghai (CN); INVENTEC CORPORATION, TAIPEI CITY (TW)

(72) Inventors: Ying-Sheng LUO, Taipei City (TW); Trista Pei-Chun CHEN, Taipei City (TW); Li-Ya SU, Taipei City (TW); Ching Hui LI, Taipei City (TW)

(21) Appl. No.: 17/654,997

(22) Filed: Mar. 16, 2022

(30) Foreign Application Priority Data
Nov. 18, 2021 (CN) 202111365847.6

(51) Int. Cl. G06Q 10/08

(52) U.S. Cl. CPC G06Q 10/0875

(57) ABSTRACT

The present disclosure provides a package packing method. The package packing method includes the following steps. An order including multiple items is received. The selected boxes with the same minimum width and minimum height are selected from multiple of boxes according to a length and a width of a main content item. The selection boxes have different depths. The minimum width and minimum height of the selection boxes are set as two-dimensional size dimension of a reference boxes. Under a condition of the two-dimensional size of the reference box, a minimum depth of the reference box and a packing scheme are calculated according to size of each of the main content item and attached content items, to fit the content items into the reference box. A target box is selected from these selected boxes according to the minimum depth of the reference box.

### CROSS REFERENCE TO RELATED APPLICATION

This application claims priority to China Application Serial Number 202111365847.6, filed Nov. 18, 2021, which is herein incorporated by reference in its entirety.

### BACKGROUND

### Field of Invention

The present invention relates to a package packing method. More particularly, the present invention relates to a package packing method and electronic device.

### Description of Related Art

In nowadays logistics operations, packing packages faster and properly has been noted. However, in high volume packing process, people may not have enough time to determine a best size of a box, a packing order and an orientation of each of content items, causing the waste of transport space and carton consumables. Therefore, how to determine the best size of the box, the packing order and the orientations of content items in a fast and proper manner is an important issue in this field.

### SUMMARY

One embodiment of the present disclosure is to provide a package packing method. The package packing method includes the following steps. An order is received. The order corresponds to a plurality of content items, and the content items include a main content item and a plurality of attached content items. Item size data and box size data are received. The item size data includes size of each of the main content item and the attached content items, and the box size data includes size of each of a plurality boxes. A plurality of selected boxes with a minimum width and a minimum height are selected from the boxes according to a length and a width of the main content item. The minimum width and the minimum height of each selected boxes are same, and the selected boxes have the different depths. The minimum width and the minimum height of the selected boxes are set as a two-dimensional size of a reference box. A packing program and a minimum depth of the reference box are calculated under condition of the two-dimensional size of a reference box, according to size of each of the main content item and the attached content items, to fit the content items into the reference box. A target box from the selected boxes is selected according to the minimum depth of the reference box.

Another embodiment of the present disclosure is to provide an electronic device. The electronic device includes a processing circuit and a memory device. The processing circuit is configured to perform following steps. An order is received. The order corresponds to a plurality of content items. The content items include a main content item and a plurality of attached content items. Item size data and box size data are received. The item size data includes size of each of the main content item and the attached content items. The box size data comprises size of each of a plurality boxes. A plurality of selected boxes with a minimum width and a minimum height are selected from the boxes according to a length and a width of the main content item. The minimum width and the minimum height of each selected boxes are same, and the selected boxes have the different depths. The minimum width and the minimum height of the selected boxes are set as a two-dimensional size of a reference box. A packing program and a minimum depth of the reference box are calculated under condition of the two-dimensional size of a reference box, according to size of each of the main content item and the attached content items, to fit the content items into the reference box. A target box from the selected boxes is selected according to the minimum depth of the reference box.

In summary, the present disclosure utilizes the main content item to select the two-dimensional size of the selected boxes, and the two-dimensional size of the selected boxes is set as the two-dimensional size of the reference box. Under the two-dimensional size of the reference box, the minimum depth of the reference box being able to contain the main content item and the attached content items is calculated, in order to calculate a best packing program.

It is to be understood that both the foregoing general description and the following detailed description are by examples, and are intended to provide further explanation of the disclosure as claimed.

### BRIEF DESCRIPTION OF THE DRAWINGS

The accompanying drawings are included to provide a further understanding of the present disclosure, and are incorporated in and constitute a part of this specification. The drawings illustrate embodiments of the present disclosure and, together with the description, serve to explain the principles of the present disclosure.

FIG. 1 is a block diagram of an electronic device in accordance with one embodiment of the present disclosure.

FIG. 2 is a schematic diagram of boxes corresponding to the box size data 15 stored in the memory device in accordance with one embodiment of the present disclosure.

FIG. 3 is a schematic diagram of a main content items and attached content items corresponding to the item size data stored in the memory device in accordance with one embodiment of the present disclosure.

FIG. 4 is a flowing chart of a package packing method in accordance with one embodiment of the present disclosure.

FIG. 5 is a schematic diagram of a reference box in accordance with one embodiment of the present disclosure.

FIG. 6 and FIG. 7 are schematic diagrams of a reserved height and a reserved width in accordance with one embodiment of the present disclosure.

FIG. 8 and FIG. 9 are schematic diagrams of orientations of the attached content items in accordance with one embodiment of the present disclosure.

FIG. 10 is a schematic diagram of a packing program in accordance with one embodiment of the present disclosure.

FIG. 11 is a schematic diagram of is a schematic diagram of a packing program in accordance with one embodiment of the present disclosure.

FIGS. 12 and 13 are schematic diagrams of a packing program of the output data in accordance with one embodiment of the present disclosure.

### DETAILED DESCRIPTION

Reference will now be made in detail to embodiments of the present disclosure, examples of which are described herein and illustrated in the accompanying drawings. While the disclosure will be described in conjunction with embodiments, it will be understood that they are not intended to limit the disclosure to these embodiments. Description of the operation does not intend to limit the operation sequence. Any structures resulting from recombination of elements with equivalent effects are within the scope of the present disclosure. It is noted that, in accordance with the standard practice in the industry, the drawings are only used for understanding and are not drawn to scale. Hence, the drawings are not meant to limit the actual embodiments of the present disclosure. In fact, the dimensions of the various features may be arbitrarily increased or reduced for clarity of discussion. Wherever possible, the same reference numbers are used in the drawings and the description to refer to the same or like parts for better understanding.

Throughout the specification and drawings, indexes 1~n may be used in the reference numbers of components and signals for ease of referring to respective components and signals. The use of indexes 1~n does not intend to restrict the count of components and signals to any specific number. In the specification and drawings, if a reference number of a particular component or signal is used without using the index, it means that the reference number is used to refer to any unspecific component or signal of corresponding component group or signal group.

Furthermore, it should be understood that the terms, “comprising”, “including”, “having”, “containing”, “involving” and the like, used herein are open-ended, that is, including but not limited to. It will be understood that, as used herein, the phrase “and/or” includes any and all combinations of one or more of the associated listed items.

In this document, the term “coupled” may also be termed “electrically coupled,” and the term “connected” may be termed “electrically connected.” “Coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments.

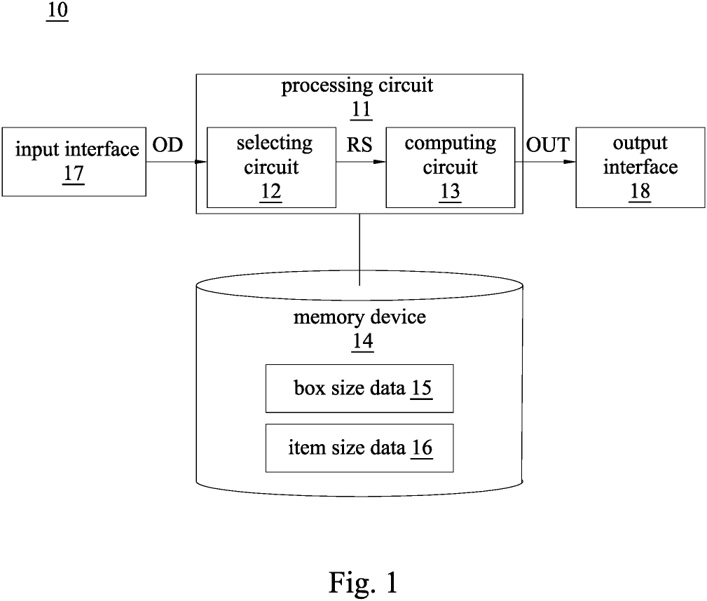

A description is provided with reference to FIG. 1. FIG. 1 is a block diagram of an electronic device 10 in accordance with one embodiment of the present disclosure. As shown in FIG. 1, the electronic device 10 includes a processing circuit 11, a memory device 14, an input interface 17 and an output interface 18. The processing circuit 11 can be implemented by a processor, microprocessor or other elements with similar functions. The input interface 17 can be implemented by a touch screen, a mouse, a keyboard, a button or other interface with functions to input data. The output interface 18 can be implemented by a display, a touch screen, a general purpose interface bus or other elements with function to display or transmit data. The processing circuit 11 includes the selecting circuit 12 and the computing circuit 13. The memory device 14 is configured to store box size data 15 and item size data 16.

In functions, the input interface 17 is configured to receive and transmit an order OD to the processing circuit 11. In response to the order OD received by the processing circuit 11, the processing circuit 11 reads the three-dimension data of each of the content items corresponding to the order OD from the item size data 16 in the memory device 14, and the processing circuit 11 receives the three-dimension data of each of the boxes for containing the content items from the box size data in the memory device 14. And, the processing circuit 11 calculates a best box size and a packing program according to the three-dimensional size of each content items corresponding to the order OD.

The processing circuit 11 includes a selecting circuit 12 and a computing circuit 13. The selecting circuit 12 is configured to select multiple selected boxes with a two-dimensional size greater and closest to a two-dimensional size (length and width) corresponding to the biggest surface of a main content item in the order OD according to the box size data 15. Since the selected boxes are selected by the same condition (such as, the two-dimensional size corresponding to the biggest surface of the main content item), a minimum width and a minimum height of each selected boxes can be same or similar to each other, and depths of the selected boxes are different from each other. The selecting circuit 12 transmits two-dimensional size RS of the selected boxes to the computing circuit 13, and then the computing circuit 13 computes the best packing program. And, how to computes the best packing program by the processing circuit 11 will be described in detail in the following embodiments.

After the processing circuit 11 determines the best target box and the packing program, the processing circuit 11 transmits the output data OUT including information of the target box and the packing program to the output interface 18. In some embodiment, the output interface 18 can convert the output data OUT to the three-dimensional image and user can rotate and observe the three-dimensional image to sequentially place the content items into the target box. In the other embodiments, the output interface 18 can transmit the output OUT to the robotic arm, and the robotic arm can place the content items into the target box according to the output data OUT. In some embodiments, the electronics device includes robotic arm (not shown), which can pack or place the content items into the target box according to the output data OUT.

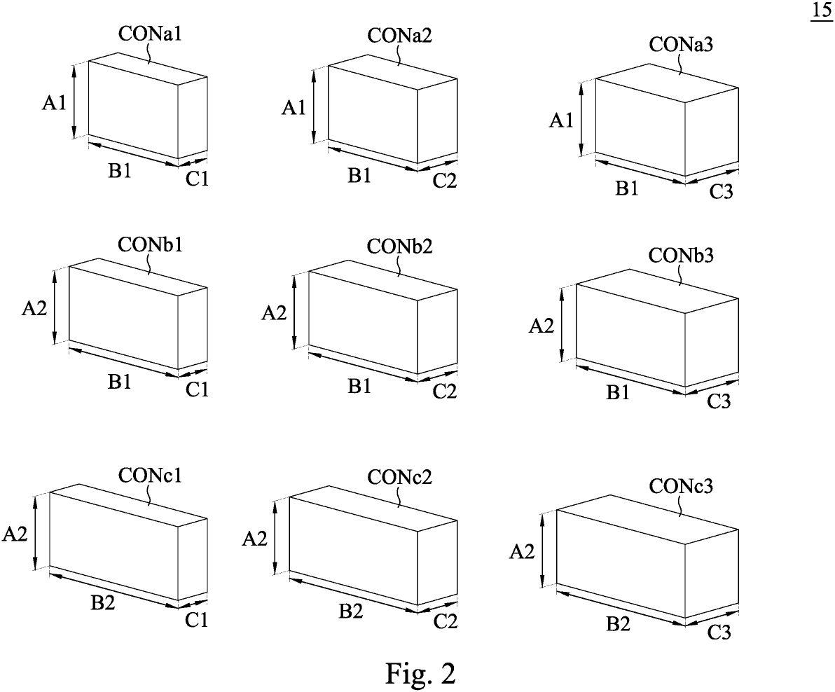

A description is provided with reference to FIG. 2. FIG. 2 is a schematic diagram of boxes CONa1~CONa3, CONb1~CONb3 and CONc1~CONc3 corresponding to the box size data 15 stored in the memory device 14 in accordance with one embodiment of the present disclosure. As shown in FIG. 2, the boxes CONa1~CONa3 have the same width B1 and the same height A1, and depths C1, C2 and C3 of each boxes CONa1~CONa3 are different from each other. Similarly, the boxes CONb1~CONb3 have the same width B1 and the same height A2, and depths C1, C2 and C3 of each boxes CONb1~CONb3 are different from each other. The boxes CONc1~CONc3 have the same width B2 and the same height A2, and depths C1, C2 and C3 of each boxes CONc1~CONc3 are different from each other.

In other words, the boxes CONa1~CONa3 have the same two-dimensional size. The depths C1, C2 and C3 of the boxes CONa1~CONa3 are different from each other. The boxes CONb1~CONb3 have the same two-dimensional size. The depths C1, C2 and C3 of the boxes CONb1~CONb3 are different from each other. The boxes CONc1~CONc3 have the same two-dimensional size. The depth C1, C2 and C3 of the boxes CONc1~CONc3 are different from each other. And, the two-dimensional sizes of the boxes CONa1, CONb1 and CONc1 are different from each other.

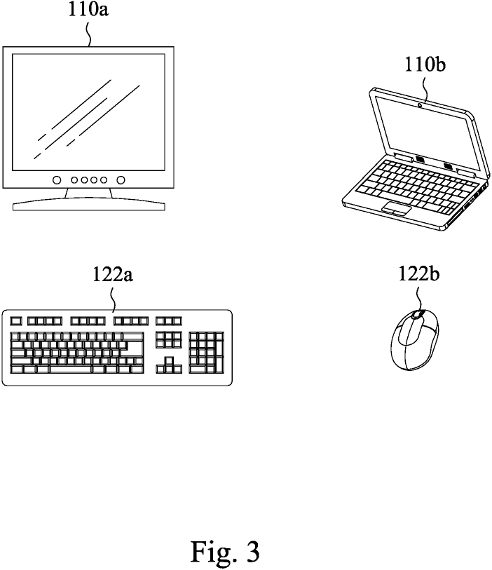

A description is provided with reference to FIG. 3. FIG. 3 is a schematic diagram of a main content items 110a and 110b and attached content items 122a and 122b corresponding to the item size data 16 stored in the memory device 14 in accordance with one embodiment of the present disclosure. As shown in FIG. 3, the main content items 110a and 110b can be considered as a display, a laptop, a touch screen, a panel or the other display/computing device. The attached content items 122a and 122b can be considered as peripheral devices (such as keyboard, mouse) or accessories. To be noted that, the device and peripheral devices as shown in FIG. 3 are for examples, the main content items 110a and 110b can be implemented by other items to be packed. And, the main content 110a and 110b can be implemented by one of the items to be packed with a relatively biggest surface, and the attached content items 122a and 122b can be implemented by the others of the items to be packed with relatively small surfaces. Therefore, it is not intend to limit the present disclosure.

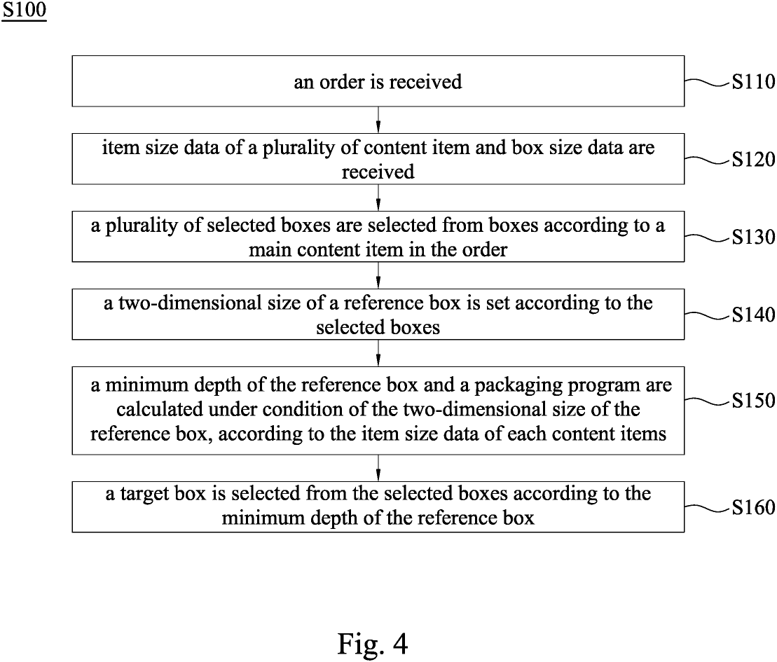

A description is provided with reference to FIG. 4. FIG. 4 is a flowing chart of a package packing method S100 in accordance with one embodiment of the present disclosure. As shown in FIG. 4, the package packing method S100 includes steps S110~S160. In step S110, an order is received. In step S120, item size data of a plurality of content items and box size data are received. In step S130, a plurality of selected boxes are selected from boxes according to a main content item in the order. In step S140, a two-dimensional size of a reference box is set according to the selected boxes. In step S150, a minimum depth of the reference box and a packing program are calculated under condition of the two-dimensional size of the reference box according to size data of each content items. In step S160, a target box is selected from the selected boxes according to the minimum depth of the reference box.

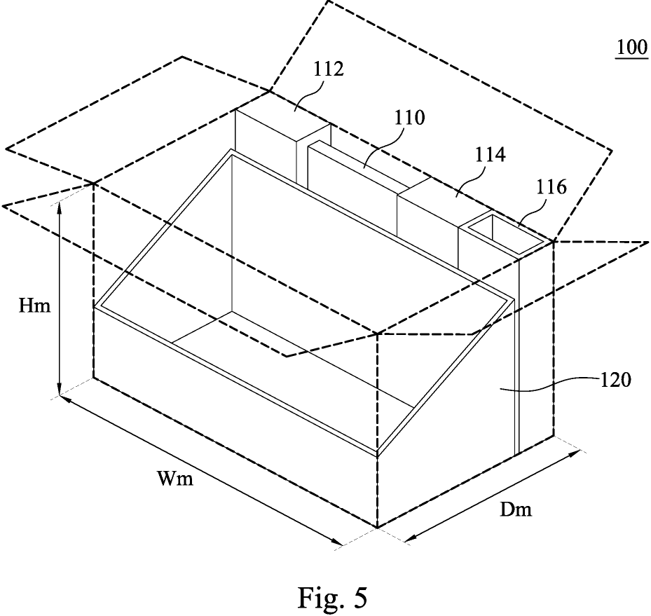

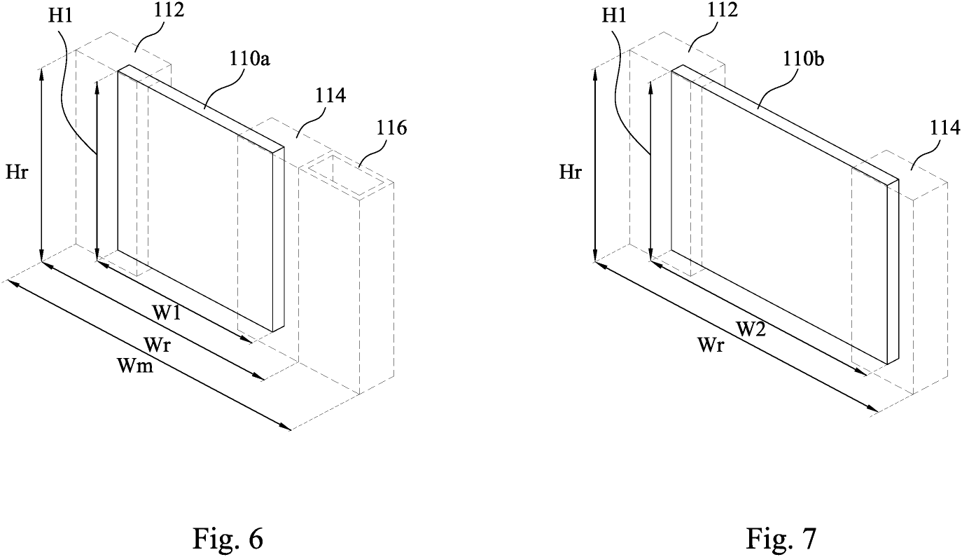

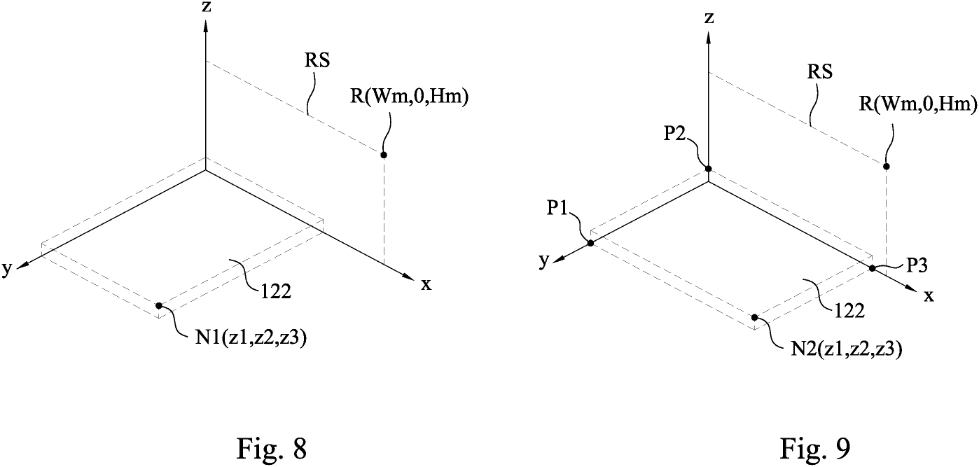

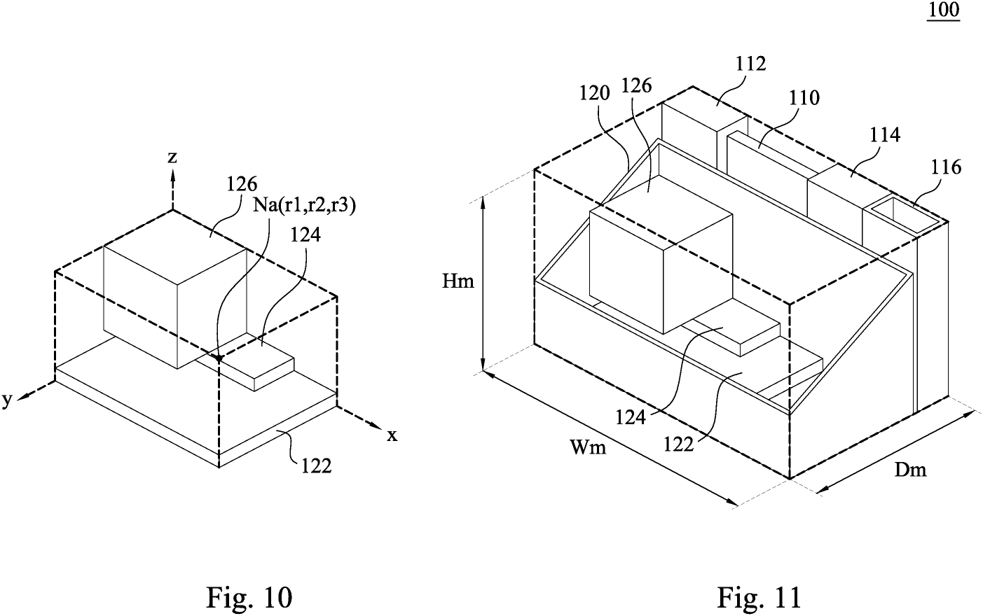

For better understanding, a description of the package packing method S100 is provided with reference to FIG. 1~FIG. 11. FIG. 5 is a schematic diagram of a reference box 100 in accordance with one embodiment of the present disclosure. FIG. 6 and FIG. 7 are schematic diagrams of a reserved height Hr and a reserved width Wr in accordance with one embodiment of the present disclosure. FIG. 8 and FIG. 9 are schematic diagrams of orientations of the attached content items in accordance with one embodiment of the present disclosure. FIG. 10 is a schematic diagram of a packing program in accordance with one embodiment of the present disclosure. FIG. 11 is a schematic diagram of is a schematic diagram of a packing program in accordance with one embodiment of the present disclosure.

In step S110, an order is received. The order corresponding to the main content item 110 and attached content items 122, 124 and 126 as shown in FIG. 11. The main content item 110 can be considered as the main content item 110a or 110b in FIG. 3. The attached content items 122, 124 and 126 can be considered as the attached content items 122a, 122b.

In step S120, item size data of a plurality of content items and box size data are received. The selecting circuit 12 in the processing circuit 11 receives/read the three-dimensional size of each of the main content item 110 and the attached content items 122, 124 and 126 from the item size data 16 stored in the memory device 14. And the selecting circuit 12 receives/read the three-dimensional size of each boxes from the box size data 15 stored in the memory device 14.

In step S130, a plurality of selected boxes are selected from boxes according to a main content item in the order. The processing circuit 11 selects the selected boxes with the minimum width Wm and the minimum height Hm enabling to contain the main content item 110, from the boxes CONa1~CONa3, CONb1~CONb3 and CONc1~CON3, according to the length W1 and height H1 of the main content item 110, as shown in FIGS. 2, 5 and 6.

For example, the width B1 of the boxes CONa1~CONa3 is greater than the length W1 of the main content item 110, the height A1 of the boxes CONa1~CONa3 is greater than the height H1 of the main content item 110. Therefore, the selecting circuit 12 in the processing circuit 11 selects the boxes CONa1~CONa3 with the minimum width B1 and the minimum height A1 in the box size data 15 as the selected boxes, to be able to contain the main content item 110, as shown in FIGS. 2, 5 and 6.

In some embodiments, the main content item 110 are packaged and fixed with buffer/fix structures 112 and 114 in usual. The buffer/fix structures 112 and 114 can be formed by the thick cardboard/anti-collision foam. As a result, the appropriate buffer/fix structures 112 and 114 can be designed according to the two-dimension of the main content item 110. And, the minimum box being able to contain the main content item 110 can be selected according to the reserved width Wr and the reserved height Hr constituted of the main content item 110 and buffer/fix structures 112 and 114, and since the operation is similar with the aforementioned step S130, the description is omitted.

In step S140, a two-dimensional size of a reference box is set according to the selected boxes. For example, the procession circuit 11 sets the width B1 and height A1 of the boxes CONa1~CONa3 as the minimum width Wm and minimum height Hm of the reference box 100.

In some embodiments, if the minimum width Wm of the reference box 100 is greater than the reserved width Wr, the space can be stuffed by a hollow/tubular structure as shown in FIG. 5 and FIG. 6. In other embodiments, if the minimum width Wm of the reference box 100 is equal to or similar with the reserved width Wr, the hollow/tubular structures can be omitted.

In step S150, a minimum depth of the reference box and a packing program are calculated under condition of the two-dimensional size of the reference box according to size data of each content items.

In some embodiments, the attached content items 122, 124 and 126 can be sort by a descending order of areas of the biggest surface, such that the attached content item with the bigger area of the biggest surface can be prior arranged. For example, since the descending order of the areas of the biggest surface of each attached content items 122, 124 and 126 is attached content items 122, 124 and 126 in order, such that the attached content items 122, 124 and 126 can be sequentially packed into the reference box 100. How to arrange the orientations of the content items will be described in detail in the following embodiments.

As shown in FIG. 8, the two-dimension RS of the reference box 100 can be indicated to a coordinate position, R (Wm, Hm, 0). Under condition of at least one orientation, the attached content item 122 cannot exceed the minimum width Wm along the x axis and the minimum height Hm along the z axis. In this case, the orientation of the attached content item 122 in FIG. 8 can be indicated to a coordinate position, N1 (z1, z2, z3). On the other hand, in FIG. 9, the orientation of the attached content item 122 can be indicated to a coordinate position, N2 (z1, z2, z3).

Therefore, under the condition of the two-dimensional size of the reference box 100, the attached content item 122 can be placed in different orientations. And, supposing the attached content item 122 is placed with the orientation as shown in FIG. 9, there will be three coordinate positions P1, P2 and P3, in the reference coordinate, to place a second one of the content items. In this case, under the condition of at least one orientation, whether the second one of content item exceeds the reference box 100 still need to be considered. If the attached content item 124 can be placed with the orientation without exceed the two-dimensional size RS of the reference box 100, a third one of the content item can then be placed.

After placing the attached content item 124, there will be five coordinate positions (not shown) to place the attached content item 126. Under the condition of at least one orientation and the different coordinate positions being able to place the content item 126, whether the content item 126 exceeds the minimum width Wm and the minimum height Hm of the reference box 100 still need to be considered, similarly. If the attached content item 126 can be placed with the orientation without exceed the two-dimensional size RS of the reference box 100, the following steps are performed.

A description of a packing program for the attached content items 122, 124 and 126 is provided with reference to FIG. 10. The packing program can be indicated to a coordinate position, Na (r1, r2, r3). In the aforementioned steps, there may have a multiple of packing programs being able to pack the attached content items 122, 124 and 126 under the condition of the two-dimensional size RS of the reference box 100. The computing circuit 13 can determine the minimum depth Dm of the reference box 100 and the best packing program (including the packing sequence and the orientation of each attached content items), as shown in FIGS. 10 and 11, through the genic algorithm, such as an adaptation function proportional to the depth of the reference box 100.

In step S160, a target box is selected from the selected boxes according to the minimum depth of the reference box. For example, if the depth Dm of the reference box 100 is greater than the depths of the boxes CONa1 and CONa2, and is less than the depth of the box CONa3, the computing circuit 130 selects the box CONa3 as the target box, such that the depth of the target box is greater than and closest to the depth Dm of the reference box 100. And, the computing circuit 130 transmits the best packing program and data of box CONa3 as the output data OUT to the output interface 18. The best packing program includes the packing sequence (such as the descending order of areas of the biggest surface of each attached content items 122, 124 and 126) and the orientation of each attached content items 122, 124 and 126.

As a result, user or the robotic arm can sequentially pack the attached content items 122, 124 and 126 in the order OD into the target box according to the packing sequence. And, the attached content items 122, 124 and 126 are packed into the target box according to the orientation of each attached content items 122, 124 and 126 by the user or the robotic arm.

In some embodiments, after calculating the best packing program, corresponding spacer block 120 can be placed with the attached content items 122, 124 and 126 in the target box, so as to avoid the attached content items 122, 124 and 126 collide with the main content item 110 during transport process.

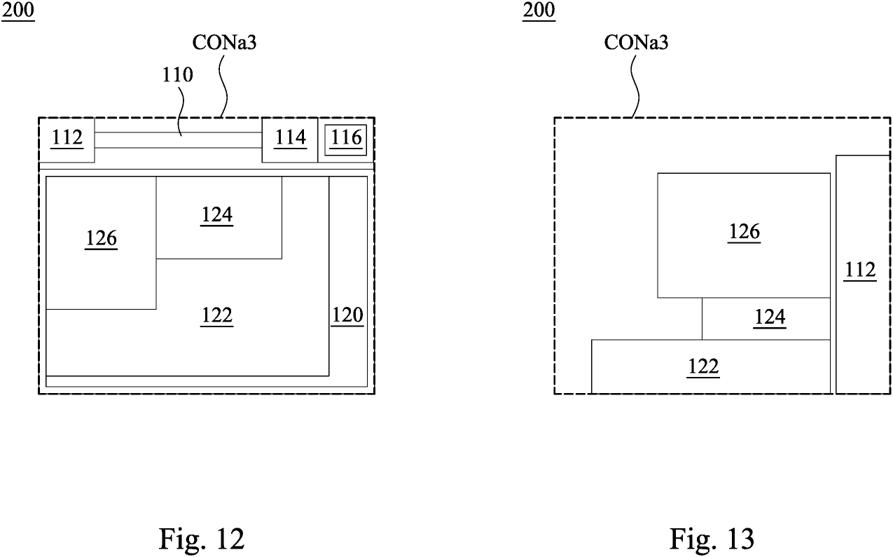

A description is provided with reference to FIGS. 12 and 13. FIGS. 12 and 13 are schematic diagrams of a packing program 200 of the output data OUT in accordance with one embodiment of the present disclosure. As shown in FIGS. 12 and 13, the output interface 18 can display a top view, a side view of the packing program 200. And, the output interface 18 can display a three-dimension graphics of the packing program 200, also. Therefore, user can review and performs the packing steps.

In summary, the present disclosure utilizes the main content item 110 to select the two-dimensional size of the selected boxes, and the two-dimensional size of the selected boxes is set as the two-dimensional size RS of the reference box 100. Under the two-dimensional size RS of the reference box 100, the minimum depth Dm of the reference box 100 being able to contain the main content item 110 and the attached content items is calculated. And, the target box is selected according to the minimum depth Dm of the reference box 100. Therefore, the present disclosure, utilizing the main content item 110 to determine the two-dimensional size RS of the reference box 100, can decrease the subsequent computing cost and computes the best packing program faster.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. A package packing method, comprising:
receiving an order, wherein the order corresponds to a plurality of content items, and wherein the content items comprises a main content item and a plurality of attached content items;
receiving item size data and box size data, wherein the item size data comprises size of each of the main content item and the attached content items, and wherein the box size data comprises size of each of a plurality boxes;
selecting a plurality of selected boxes with a minimum width and a minimum height from the boxes according to a length and a width of the main content item, wherein the minimum width and the minimum height of each selected boxes are same, and wherein the selected boxes have different depths;
setting the minimum width and the minimum height of the selected boxes as a two-dimensional size of a reference box;
calculating a packing program and a minimum depth of the reference box under condition of the two-dimensional size of a reference box, according to size of each of the main content item and the attached content items, to fit the content items into the reference box; and
selecting a target box from the selected boxes according to the minimum depth of the reference box.

2. The package packing method of claim 1, further comprising:
outputting the target box and the packing program.

3. The package packing method of claim 1, wherein the packing program comprises a packing sequence and an orientation of each attached content items.

4. The package packing method of claim 3, wherein the packing sequence is a descending order of areas of a biggest surface of each attached content items.

5. The package packing method of claim 3, further comprising:
packing the attached content items into the target box according the packing sequence and the orientation of each attached content items.

6. The package packing method of claim 3, further comprising:
packing the attached content items into the target box according to the packing sequence and the orientation of each attached content items .

7. The package packing method of claim 1, wherein the minimum width of the selected boxes is greater than and closest to the length of the main content item.

8. The package packing method of claim 1, wherein the minimum height of the selected boxes is greater than and closest to the width of the main content item.

9. The package packing method of claim 1, wherein the target box is selected from the selected boxes according to the minimum depth of the reference box, and a depth of the target box is greater than or equal to the minimum depth.

10. The package packing method of claim 1, wherein the main content item is one of the content items with a relatively biggest surface, and wherein the attached content items are the others of the content items with relatively small surfaces.

11. An electronic device, comprising:
a processing circuit;
a memory device, wherein the processing circuit is configured to:
receiving an order, wherein the order corresponds to a plurality of content items, and wherein the content items comprises a main content item and a plurality of attached content items;
receiving item size data and box size data, wherein the item size data comprises size of each of the main content item and the attached content items, and wherein the box size data comprises size of each of a plurality boxes;
selecting a plurality of selected boxes with a minimum width and a minimum height from the boxes according to a length and a width of the main content item, wherein the minimum width and the minimum height of each selected boxes are same, and wherein the selected boxes have different depths;
setting the minimum width and the minimum height of the selected boxes as a two-dimensional size of a reference box;
calculating a packing program and a minimum depth of the reference box under condition of the two-dimensional size of a reference box, according to size of each of the main content item and the attached content items, to fit the content items into the reference box; and
selecting a target box from the selected boxes according to the minimum depth of the reference box.

12. The electronic device of claim 11, wherein the processing circuit is further configured to:
outputting the target box and the packing program.

13. The electronic device of claim 11, wherein the packing program comprises a packing sequence and an orientation of each attached content items.

14. The electronic device of claim 13, wherein the packing sequence is a descending order of areas of a biggest surface of each attached content items.

15. The electronic device of claim 13, wherein the electronic device is configured to:
packing the attached content items into the target box according to the packing sequence and the orientation of each attached content items.

16. The electronic device of claim 13, wherein the electronic device is configured to:
packing the attached content items into the target box according to the packing sequence and the orientation of each attached content items.

17. The electronic device of claim 11, wherein the minimum width of the selected boxes is greater than and closest to the length of the main content item.

18. The electronic device of claim 11, wherein the minimum height of the selected boxes is greater than and closest to the width of the main content item.

19. The electronic device of claim 11, wherein the target box is selected from the selected boxes according to the minimum depth of the reference box, and a depth of the target box is greater than or equal to the minimum depth.

20. The electronic device of claim 11, wherein the main content item is one of the content items with a relatively biggest surface, and wherein the attached content items are the others of the content items with relatively small surfaces.
